(19) United States
(12) Patent Application Publication
(10) Pub. No.: US 2015/0343968 A1
(43) Pub. Date: Dec. 3, 2015

(54) HARNESS CLAMP

(71) Applicant: SUMITOMO WIRING SYSTEMS, LTD., Mie (JP)

(72) Inventor: Daiki NAGAYASU, Mie (JP)

(73) Assignee: SUMITOMO WIRING SYSTEMS, LTD., Mie (JP)

(21) Appl. No.: 14/709,919

(22) Filed: May 12, 2015

(30) Foreign Application Priority Data
May 30, 2014 (JP) 2014-112069

(51) Int. Cl. B60R 16/02; F16L 3/233; F16L 3/137

(52) U.S. Cl. CPC B60R 16/0215; F16L 3/137; F16L 3/233

(57) ABSTRACT

A harness clamp that can suppress the rotation of the harness clamp around an electric wire or an electric wire bundle is provided. A harness clamp includes a fixing portion, a belt portion, and a belt locking portion. The fixing portion includes a supporting portion that can support an electric wire or an electric wire bundle. The supporting portion includes a wall portion formed to extend in a second direction intersecting a first direction that is a direction in which the electric wire or the electric wire bundle extends, and a front end-side edge portion of the wall portion is provided with a recessed portion that can accommodate at least a portion of an outer circumferential portion of the electric wire or the electric wire bundle.

### TECHNICAL FIELD

The present invention relates to a harness clamp for fixing an electric wire or an electric wire bundle to a fixing target.

### BACKGROUND ART

A wire harness to be mounted in a vehicle, such as an automobile, may be fixed to a fixing counterpart portion, such as a metal panel constituting a vehicle body, using a harness clamp.

For example, a harness clamp disclosed in JP 2013-118741A has a pair of large projecting portions and a pair of small projecting portions that are provided on the side of a surface that supports a wire harness. The wire harness is supported by being sandwiched between the pair of large projecting portions or between the pair of small projecting portions. The pair of large projecting portions and the pair of small projecting portions are engaged with the wire harness, and prevent the displacement of the wire harness in the extending direction and the rotation of the harness clamp around the wire harness.

It should be noted that JP 2013-118741A discloses that the large projecting portions prevent the displacement or the like of a plurality of electric wires (electric wire bundle), and that the small projecting portions prevent the displacement or the like of one electric wire.

JP 2013-118741A is an example of related art.

### SUMMARY OF THE INVENTION

When an external force that causes, for example, the rotation of the harness clamp around the electric wire or the electric wire bundle is large in the harness clamp disclosed in JP 2013-118741A, collapsing deformation may occur in which the large projecting portions and the small projecting portions are deformed and collapse in a direction orthogonal to the direction in which the electric wire or the electric wire bundle extends. Hereinafter, such an external force is referred to as “laying-direction external force”.

The projecting portions are likely to collapse and be deformed by the laying-direction external force due to their shape. In this case, the projecting portions are likely to be disengaged from the electric wire or the electric wire bundle, and therefore, there is a concern that the rotation of the harness clamp around the electric wire or the electric wire bundle cannot be prevented.

An object of the present invention is to provide a harness clamp that is to be used for fixing an electric wire or an electric wire bundle to a fixing target and that can suppress the rotation of the harness clamp around the electric wire or the electric wire bundle.

A harness clamp according to a first aspect is a harness clamp for fixing an electric wire or an electric wire bundle to a fixing counterpart portion, the harness clamp including a fixing portion that includes a supporting portion capable of supporting the electric wire or the electric wire bundle and that can be fixed to the fixing counterpart portion, a belt portion that is to be wound around the electric wire or the electric wire bundle on the supporting portion side of the fixing portion, and a belt locking portion that is to be locked to the belt portion to maintain the belt portion in a winding form in which the belt portion is wound around the electric wire or the electric wire bundle, wherein the supporting portion includes a wall portion formed to extend in a second direction intersecting a first direction that is a direction in which the electric wire or the electric wire bundle extends, and a front end-side edge portion of the wall portion is provided with a recessed portion that can accommodate at least a portion of an outer circumferential portion of the electric wire or the electric wire bundle.

A harness clamp according to a second aspect is an aspect of the harness clamp according to the first aspect. In the harness clamp according to the second aspect, the supporting portion further includes an auxiliary wall portion formed to be continuous with the wall portion and to extend in the first direction.

A harness clamp according to a third aspect is an aspect of the harness clamp according to the second aspect. In the harness clamp according to the third aspect, the auxiliary wall portion includes a pair of bilateral auxiliary wall portions formed outside on both sides of the recessed portion.

A harness clamp according to a fourth aspect is an aspect of the harness clamp according to the third aspect. In the harness clamp according to the fourth aspect, the wall portion is lower than the bilateral auxiliary wall portions.

A harness clamp according to a fifth aspect is an aspect of the harness clamp according to the fourth aspect. In the harness clamp according to the fifth aspect, the wall portion is formed in a shape in which a height of portions that connect portions continuous with the bilateral auxiliary wall portions and the recessed portion gradually decreases toward the recessed portion.

A harness clamp according to a sixth aspect is an aspect of the harness clamp according to any one of the second to fifth aspects. In the harness clamp according to the sixth aspect, the belt portion and the fixing portion are separately formed, the fixing portion is provided with a pair of belt inserting hole portions that is partitioned by a partition plate portion and into which the two end portions of the belt portion can be respectively inserted, and the auxiliary wall portion includes a partition-side auxiliary wall portion formed to extend toward the supporting portion side from the partition plate portion.

A harness clamp according to a seventh aspect is an aspect of the harness clamp according to any one of the first to sixth aspects. In the harness clamp according to the seventh aspect, the recessed portion is narrower than the electric wire.

In the above-described aspects, the harness clamp includes the fixing portion having the supporting portion that can support the electric wire or the electric wire bundle. The supporting portion includes the wall portion formed to extend in the second direction intersecting the first direction that is a direction in which the electric wire or the electric wire bundle extends. The front end-side edge portion of the wall portion is provided with the recessed portion that can accommodate at least a portion of the outer circumferential portion of the electric wire or the electric wire bundle. In this case, the edges of the recessed portion come into contact with the electric wire and thus the rotation of the harness clamp around the electric wire is suppressed. Moreover, the wall portion extending in the second direction is unlikely to collapse and be deformed by the laying-direction external force. Therefore, the edges of the recessed portion become unlikely to come out of contact with the electric wire, thus making it possible to suppress the rotation of the harness clamp.

In the above-described second aspect, the harness clamp further includes the auxiliary wall portion formed to be continuous with the wall portion and extend in the first direction. In this case, the wall portion is unlikely to collapse in the first direction. Therefore, it is possible to suppress the displacement of the electric wire in the first direction in addition to the rotation of the harness clamp around the electric wire.

In the above-described third aspect, the auxiliary wall portion includes the pair of bilateral auxiliary wall portions formed outside on two sides of the recessed portion. In this case, the pair of bilateral auxiliary wall portions comes into contact with the electric wire bundle, thus making it possible to suppress the rotation of the harness clamp around the electric wire bundle. Therefore, the rotation of the harness clamp around the electric wire or the electric wire bundle in a variety of forms can be further suppressed by the recessed portion of the wall portion and the pair of auxiliary wall portions.

In the above-described fourth aspect, the wall portion is lower than the bilateral auxiliary wall portions. In this case, the bilateral auxiliary wall portions are likely to come into contact with the electric wire bundle, thus making it possible to further suppress the rotation of the harness clamp around the electric wire or the electric wire bundle.

In the above-described fifth aspect, the wall portion is formed in a shape in which the height of portions that connect portions continuous with the bilateral auxiliary wall portions and the recessed portion gradually decreases toward the recessed portion. In this case, the electric wire is easily guided to the inside of the recessed portion. This makes it possible to further suppress the rotation of the harness clamp around the electric wire.

In the above-described sixth aspect, the belt portion and the fixing portion are separately formed, and the fixing portion is provided with a pair of belt inserting hole portions that is partitioned by a partition plate portion and into which the two end portions of the belt portion can be respectively inserted. The auxiliary wall portion includes the partition-side auxiliary wall portion formed to extend toward the supporting portion side from the partition plate portion. In this case, the displacement of the electric wire can be suppressed by the partition-side auxiliary wall portion formed to extend toward the supporting portion side from the partition plate portion that forms the holes into which the belt portion is inserted.

In the above-described seventh aspect, the recessed portion is narrower than the electric wire. In this case, the edges of the recessed portion are likely to come into contact with the electric wire, thus making it possible to further suppress the rotation of the harness clamp around the electric wire.

### BRIEF DESCRIPTION OF THE DRAWINGS

FIG. 1 is a perspective view of a harness clamp according to a first embodiment.

FIG. 2 is a front view of the harness clamp according to the first embodiment.

FIG. 3 is a cross-sectional view of the harness clamp according to the first embodiment.

FIG. 4 is a side view of a fixing portion of the harness clamp according to the first embodiment.

FIG. 5 is a cross-sectional view of the fixing portion of the harness clamp according to the first embodiment.

FIG. 6 is a plan view of the fixing portion of the harness clamp according to the first embodiment.

FIG. 7 is a front view of the harness clamp according to the first embodiment.

FIG. 8 is a cross-sectional view of a harness clamp according to a second embodiment.

### EMBODIMENTS OF THE INVENTION

Hereinafter, embodiments of the present invention will be described with reference to the attached drawings. The following embodiments are merely specific examples of the present invention, and are not to restrict the technical scope of the present invention.

### First Embodiment

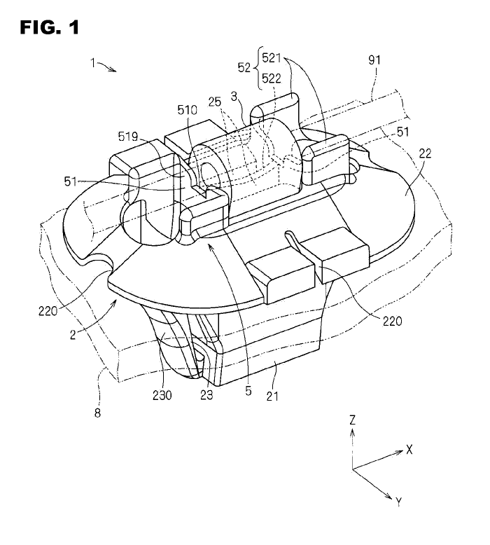

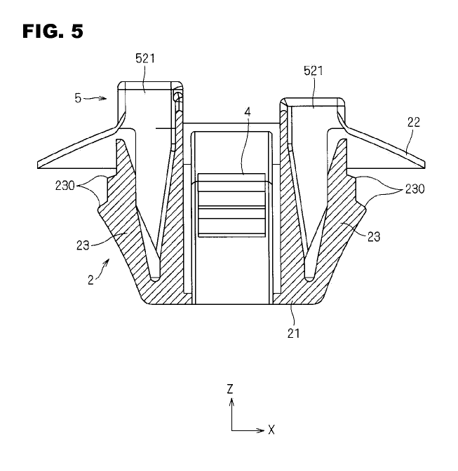

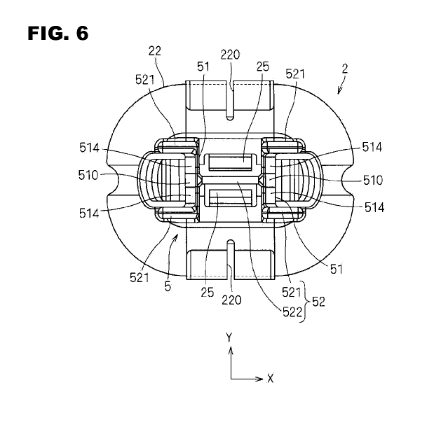

A harness clamp 1 according to this embodiment will be described with reference to FIGS. 1 to 6. The harness clamp 1 fixes an electric wire 91 or an electric wire bundle 92 to a fixing counterpart portion 8. It should be noted that FIGS. 1 to 3 shows that the harness clamp 1 fixes an electric wire 91 and FIG. 6 shows that the harness clamp 1 fixes an electric wire bundle 92.

In this embodiment, one example of the fixing counterpart portion 8 is a metal panel constituting a vehicle body. In this embodiment, a case will be described in which the harness clamp 1 is fixed to a fixing counterpart portion 8 provided with a hole (referred to as “fixing hole” hereinafter) that penetrates the fixing counterpart portion 8 in the thickness direction and that is used for fixing the harness clamp 1.

### Harness Clamp

The harness clamp 1 includes a fixing portion 2, a belt portion 3, and a belt locking portion 4. The harness clamp 1 is formed by, for example, injection molding a synthetic resin material. It should be noted that in this embodiment, the fixing portion 2 and the belt portion 3 of the harness clamp 1 are separately formed and the fixing portion 2 is provided with the belt locking portion 4.

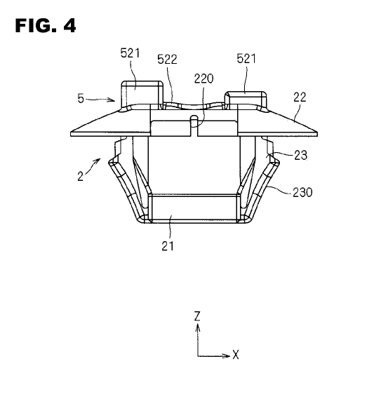

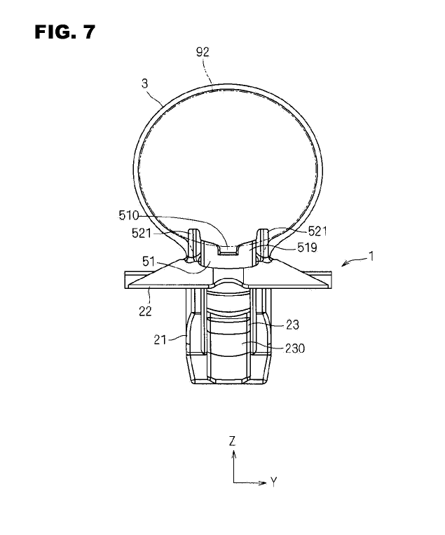

FIGS. 1 to 3 are respectively a perspective view, a front view, and a cross-sectional view of the harness clamp 1. In FIGS. 1 to 3, the electric wire 91 is drawn by phantom lines. FIGS. 4 to 6 are respectively a side view, a cross-sectional view, and a plan view of the fixing portion 2 of the harness clamp 1. FIG. 7 is a front view of the harness clamp 1. In FIG. 7, the electric wire bundle 92 is drawn by phantom lines.

The electric wire 91 is, for example, an insulated electric wire including a conductor that contains copper, aluminum, or the like as a main component and an insulating coating that covers the circumference of the conductor. Moreover, the electric wire bundle 92 is constituted by a plurality of electric wires 91.

### Harness Clamp: Fixing Portion

The fixing portion 2 is a portion that can be fixed to the fixing counterpart portion 8. The fixing portion 2 includes a supporting portion 5 that can support the electric wire 91 or the electric wire bundle 92. In this embodiment, the supporting portion 5 includes two wall portions 51.

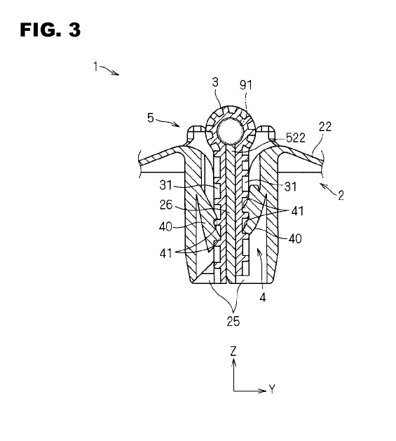

Moreover, in this embodiment, as shown in FIG. 3, the fixing portion 2 is provided with a pair of belt inserting hole portions 25 that is partitioned by a partition plate portion 26 and into which the two end portions of the belt portion 3 can be respectively inserted. In this embodiment, the fixing portion 2 includes an inserted portion 21 that is to be inserted into the fixing hole provided in the fixing counterpart portion 8 and a skirt portion 22 that can be elastically deformed.

More specifically, in this embodiment, the fixing portion 2 includes the inserted portion 21 formed to extend in one direction, the pair of belt inserting hole portions 25 penetrating the inserted portion 21 in the one direction, the two wall portions 51 formed on the two sides of the belt inserting hole portions 25, and the skirt portion 22 formed around the inserted portion 21.

### Harness Clamp: Fixing Portion (Inserted Portion, Skirt Portion, and Belt Inserting Hole Portion)

In this embodiment, the inserted portion 21 of the fixing portion 2 in the harness clamp 1 is a portion to be inserted into the fixing hole formed in the fixing counterpart portion 8. In the examples shown in FIGS. 1 to 6, the inserted portion 21 has a projecting shape. However, the inserted portion 21 may also be formed in a cylindrical shape, a rectangular parallelepiped shape, or the like.

Moreover, in the examples shown in FIGS. 1 to 7, the inserted portion 21 is provided with a pair of locking claws 23 that can be locked to the fixing counterpart portion 8. The locking claws 23 are formed in a shape projecting from the outer circumferential portion of the inserted portion 21 toward the outer circumferential side. Also, the locking claws 23 are formed such that the front end-side portions serve as a free end and can be elastically deformed toward the inside (inserted portion 21 side). By locking the locking claws 23 to the circumferential edge portion of the fixing hole of the fixing counterpart portion 8, the harness clamp 1 is fixed to the fixing counterpart portion 8.

Moreover, in the examples shown in FIGS. 1 to 7, the front end-side portions of the locking claws 23 are provided with a plurality of locking surfaces 230. The plurality of locking surfaces 230 are formed in a stepwise manner in a direction in which the harness clamp 1 is inserted (referred to as “inserting direction Z” hereinafter). It should be noted that the inserted portion 21 is formed in the inserting direction Z, which is the same direction as the above-described one direction.

The locking claws 23 are elastically deformed toward the inside as the inserted portion 21 is inserted into the fixing hole of the fixing counterpart portion 8, and return to the form before the elastic deformation after the locking surfaces 230 pass the fixing hole. In this embodiment, any one of the locking surfaces 230 is locked to the circumferential edge portion of the fixing hole. That is, in the harness clamp 1 of this embodiment, the locking surface 230 that is locked to the circumferential edge portion of the fixing hole is changed depending on the thickness of the fixing counterpart portion 8.

The skirt portion 22 is formed to surround the inserted portion 21. The skirt portion 22 is a portion that is to be locked to the surface on the side opposite to the surface of the fixing counterpart portion 8 to which the locking surface 230 is locked. That is, the skirt portion 22 is formed on the supporting portion 5 side with respect to the locking claws 23 in the harness clamp 1 inserting direction Z.

In the examples shown in FIGS. 1 to 6, the skirt portion 22 is formed in an oval shape in which a pair of linear portions connect a pair of arc-shaped portions in a planar view in which the harness clamp 1 is viewed from the supporting portion 5 side in the inserting direction Z. It should be noted that the skirt portion 22 may also be formed in a perfect circular shape, a rectangular shape with rounded corners, or the like in the above-described planar view.

Also, the skirt portion 22 is formed in a shape that is gradually inclined to the locking claws 23 side toward the outer circumferential portion of the skirt portion 22. That is, the skirt portion 22 is formed in a disk spring shape and can be elastically deformed in the harness clamp 1 inserting direction Z.

Also, in the examples shown in FIGS. 1 to 6, a slit 220 is provided in a part of the skirt portion 22. The slit 220 makes it easier to elastically deform the skirt portion 22.

The skirt portion 22 is elastically deformed toward the supporting portion 5 side in the inserting direction Z as the inserted portion 21 is inserted into the fixing hole of the fixing counterpart portion 8. At this time, the fixing counterpart portion 8 is sandwiched between the locking claws 23 and the skirt portion 22 by the force of the skirt portion 22, which returns to the original shape, pressing the circumferential edge portion of the fixing hole. Thus, the harness clamp 1 is fixed to the fixing counterpart portion 8.

The pair of belt inserting hole portions 25 is a portion that is partitioned by the partition plate portion 26 and through which a belt portion 3, which will be described later, is to be passed. In this embodiment, the pair of belt inserting hole portions 25 is a through hole that penetrates the inserted portion 21 of the fixing portion 2 in the inserting direction Z.

Moreover, in this embodiment, the belt inserting hole portions 25 are provided with belt locking portions 4. This will be described in detail later.

The partition plate portion 26 is a planar portion that is formed between the pair of belt inserting hole portions 25. In this embodiment, the partition plate portion 26, which partitions the pair of inserting hole portions 25, is formed to penetrate the inserted portion 21 in the inserting direction Z.

### Harness Clamp: Belt Portion and Belt Locking Portion

The belt portion 3 is a portion that is wound around the electric wire 91 or the electric wire bundle 92 on the supporting portion 5 side of the fixing portion 2. In this embodiment, the belt portion 3 is a band-shaped member, and is provided with a plurality of locking portions 31 that can be locked to locking claws 40 of the belt locking portions 4, which will be described later, in the longitudinal direction of the belt portion 3.

In this embodiment, the locking portions 31 of the belt portion 3 are formed in a recessed shape that is open in one main surface. The plurality of locking portions 31 are formed with intervals in the longitudinal direction of the belt portion 3.

The belt locking portions 4 are portions that are to be locked to the belt portion 3 to maintain the belt portion 3 in the form in which the belt portion 3 is wound around the electric wire 91 or the electric wire bundle 92. In this embodiment, the belt locking portions 4 are formed in the fixing portion 2. More specifically, in this embodiment, the belt locking portions 4 are formed inside the belt inserting hole portions 25 of the fixing portion 2.

In this embodiment, the belt locking portions 4 include the two locking claws 40 that are respectively formed inside the pair of belt inserting hole portions 25. The locking claws 40 are portions that can be locked to the locking portions 31 of the belt portion 3. The locking claws 40 are formed such that the front end-side portions serve as a free end and can be elastically deformed toward the surfaces opposed to the partition plate portion 26 in the belt inserting hole portions 25. It should be noted that in the examples shown in FIGS. 1 to 6, the locking claws 40 are provided with two locked portions 41 having a projecting shape that are to be locked to the locking portions 31 of the belt portion 3.

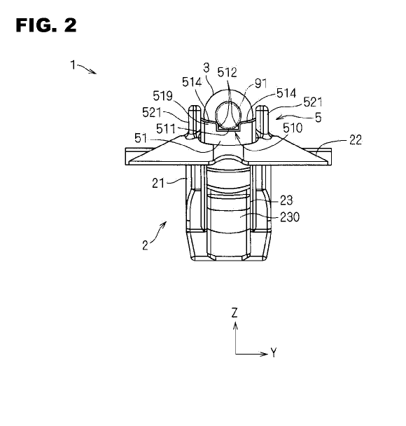

As shown in FIGS. 2 and 7, when the harness clamp 1 is attached to the fixing counterpart portion 8, the belt portion 3 is wound around the electric wire 91 or the electric wire bundle 92. The two end portions of the belt portion 3 wound around the electric wire 91 or the electric wire bundle 92 are respectively inserted into the pair of belt inserting hole portions 25 formed in the fixing portion 2. In this embodiment, both of the two end portions of the belt portion 3 are respectively inserted into the pair of belt inserting hole portions 25 from the supporting portion 5 side of the fixing portion 2.

In this embodiment, the locking portions 31 of the belt portion 3 inserted into the belt inserting hole portions 25 are locked to the locked portions 41 of the belt locking portions 4 formed inside the belt inserting hole portions 25. By locking the locking portions 31 of the belt portion 3 at the position corresponding to the thickness of the electric wire 91 or the electric wire bundle 92 around which the belt portion 3 is wound and the locked portions 41 of the belt locking portions 4 to each other, the movement of the belt portion 3 in the third direction Z is limited.

In this embodiment, the way in which the two end portions of the belt portion 3 wound around the electric wire 91 or the electric wire bundle 92 are inserted into the belt inserting hole portions 25 and the movement of the belt portion 3 in the inserting direction Z is limited is by winding the belt portion 3 that is maintained by the belt locking portions 4.

### Harness Clamp: Fixing Portion (Supporting Portion)

As shown in FIGS. 1 to 6, the supporting portion 5 in the fixing portion 2 includes the wall portions 51 formed to extend in a second direction Y intersecting a first direction X in which the electric wire 91 or the electric wire bundle 92 extends. Front end side-edge portions 519 of the wall portions 51 are each provided with a recessed portion 510 that can accommodate at least a portion of the outer circumferential portion of the electric wire 91 or the electric wire bundle 92. Also, in this embodiment, the supporting portion 5 further includes auxiliary wall portions 52 formed to be continuous with the wall portions 51 and to extend in the first direction. It should be noted that in this embodiment, the auxiliary wall portions 52 include a pair of bilateral auxiliary wall portions 521 and a partition-side auxiliary wall portion 522.

In this embodiment, the wall portions 51 are planar portions formed in the second direction Y. In this embodiment, the supporting portion 5 includes the two wall portions 51.

The pair of belt inserting hole portions 25 is formed between the two wall portions 51. The direction in which the two wall portions 51 are opposed to each other is the same as the above-described first direction X.

Moreover, the second direction Y is a direction intersecting the first direction X orthogonally or diagonally. In this embodiment, the second direction Y is defined as a direction intersecting the first direction X orthogonally. It should be noted that in this embodiment, a plane defined by the first direction X and the second direction Y intersects the inserting direction Z orthogonally.

The front end-side edge portions 519 of the wall portions 51 are each provided with a recessed portion 510. It should be noted that the “front end-side edge portion 519 of the wall portion 51” means an edge portion on a side opposite to a portion of the wall portion 51 that is continuous with the fixing portion 2.

In this embodiment, the recessed portions 510 are each provided with a bottom portion 511 and a pair of side wall portions 512 that is continuous with the bottom portion 511 at a certain angle. Moreover, the direction in which the pair of side wall portions 512 in the recessed portion 510 oppose each other is the same as the second direction Y.

In this embodiment, the pairs of bilateral auxiliary wall portions 521 are planar portions formed outside on the two sides of the recessed portions 510. In this embodiment, the pairs of bilateral auxiliary wall portions 521 are formed on the two sides of the wall portions 51 in the second direction Y. However, the wall portions 51 may also be formed in a form including portions projecting outward from the pairs of bilateral auxiliary wall portions 521, intersecting the pairs of bilateral auxiliary wall portions 521.

In this embodiment, the partition-side auxiliary wall portion 522 is a planar portion formed to be continuous with the partition plate portion 26. In this specification, in a planar portion that partitions the pair of belt inserting hole portions 25, a portion formed to penetrate the inserted portion 21 is referred to as “partition plate portion 26”, and a portion formed to extend toward the supporting portion 5 side from the partition plate portion 26, that is, a portion formed to extend toward the supporting portion 5 side with respect to the inserted portion 21 is referred to as “partition-side auxiliary wall portion 522”.

Also, the partition-side auxiliary wall portion 522 is formed to be continuous with intermediate positions of the wall portions 51 in the second direction Y. Also, in this embodiment, the recessed portions 510 are formed at the intermediate positions of the front end-side edge portions 519 in the second direction Y. For example, the electric wire 91 around which the belt portion 3 is wound is arranged on the partition-side auxiliary wall portion 522, which is continuous with the partition plate portion 26. Therefore, if the recessed portions 510 and the partition-side auxiliary wall portion 522 formed to be lined up in a row, it becomes easy to accommodate the electric wire 91 in the recessed portions 510.

Moreover, in this embodiment, the entire wall portions 51 are formed to extend in the second direction Y. That is, the wall portions 51 are formed in a linear shape in the above-described planar view. However, for example, the wall portions 51 may also be formed such that a portion of the wall portion 51 provided with the recessed portion 510 is formed in the second direction Y and a portion of the wall portion 51 other than that portion is formed in a direction other than the second direction Y. That is, only a portion of the wall portion 51 provided with the recessed portion 510 may be formed in the second direction Y.

Also, the wall portions 51 may be formed in a curved shape in the above-described planar view. In this case, the wall portions 51 may be formed such that the direction in which the two side wall portions 512 in the recessed portion 510 oppose each other is the same as the second direction Y.

Moreover, in this embodiment, angles formed by the bottom portion 511 and the side wall portions 512 in each of the recessed portions 510 are 90 degrees. However, the bottom portion 511 and the side wall portions 512 may also define angles other than 90 degrees. Also, the bottom portion 511 may be continuous with the pair of side wall portion 512 at no angle, that is, a curved surface may be formed in each of the recessed portion 510.

Moreover, in this embodiment, the recessed portion 510 is narrower than the electric wire 91. More specifically, in this embodiment, the recessed portion 510 is formed to have a width smaller than the diameter of the electric wire 91 in the second direction Y.

In addition, in this embodiment, the recessed portion 510 is formed to have a height (dimension in the inserting direction Z) smaller than the diameter of the electric wire 91. In this case, in the state in which the electric wire 91 is fixed to the fixing counterpart portion 8 by the harness clamp 1, the electric wire 91 is in contact with the bottom portions 511 of the recessed portions 510. This makes it possible to limit the movement of the electric wire toward the inserted portion 21 side in the inserting direction Z.

Moreover, in this embodiment, the wall portions 51 are lower than the bilateral auxiliary wall portions 521. More specifically, in this embodiment, the wall portions 51 are formed to have a dimension smaller than those of the bilateral auxiliary wall portions 521 in the inserted direction Z.

Moreover, in this embodiment, the wall portions 51 are formed in a shape in which the height of connecting portions 514 that connect portions continuous with the bilateral auxiliary wall portions 521 and the recessed portion 510 gradually decreases toward the recessed portion 510. FIG. 2 shows that the connecting portions 514 are linearly inclined. It should be noted that the connecting portions 514 may also be curved and inclined. Also, the connecting portions 514 may be formed so as to have a plurality of steps and be inclined toward the recessed portion 510 in a stepwise manner.

Moreover, FIGS. 1 to 7 show the harness clamp 1 including the two pairs of bilateral auxiliary wall portions 521 that are different in height. In this case, when the harness clamp 1 is attached to the fixing counterpart portion 8, it is easy to confirm the vertical direction and the horizontal direction of the harness clamp 1. However, the two pairs of bilateral auxiliary wall portions 521 may have the same height.

### Operation and Effects

In this embodiment, as shown in FIG. 2, at least a portion of the outer circumferential portion of the electric wire 91 is accommodated inside the recessed portions 510 of the wall portions 51. In this case, the edges of the recessed portions 510 (border portions between the side wall portions 512 and the connecting portions 514) come into contact with the electric wire 91, and the rotation of the harness clamp around the electric wire 91 due to an external force in the second direction Y is suppressed. Moreover, the wall portions 51 formed in the second direction Y are unlikely to collapse and be deformed by the external force in the second direction Y. Therefore, in this embodiment, the state in which the rotation of the harness clamp is suppressed is unlikely to be released.

In this embodiment, the harness clamp 1 has the auxiliary wall portion 52 including the pair of bilateral auxiliary wall portions 521 formed to be continuous with the wall portion 51 and to extend in the first direction X and the partition-side auxiliary wall portion 522. In this case, the pair of bilateral auxiliary wall portions 521 and the partition-side auxiliary wall portion 522, which extend in the first direction X, cause the wall portion 51 to be unlikely to collapse and be deformed in the first direction X. This makes it possible to limit the movement of the electric wire 91 in the first direction X.

In this embodiment, the auxiliary wall portion 52 includes the pair of bilateral auxiliary wall portions 521 formed to the outside of the two sides of the recessed portion 510. In this case, the recessed portion 510 of the wall portion 51 limits the rotation of the harness clamp 1 around the electric wire 91, whereas the pair of bilateral auxiliary wall portions 521 limits the rotation of the harness clamp 1 around the electric wire bundle 92. This makes it possible to fix both one electric wire 91 and the electric wire bundle 92 constituted by the plurality of electric wire 91 to the fixing counterpart portion 8 using one type of the harness clamp 1. That is, the harness clamp 1 has excellent versatility.

In this embodiment, the wall portion 51 is lower than the bilateral auxiliary wall portions 521. In this case, the bilateral auxiliary wall portions 521 are likely to come into contact with the electric wire bundle 92. This makes it possible to further suppress the rotation of the harness clamp 1 around the electric wire bundle 92.

In this embodiment, the wall portions 51 are formed in a shape in which the height of the connecting portions 514 that connect portions continuous with the bilateral auxiliary wall portions 521 and the recessed portion 510 gradually decreases toward the recessed portion 510. In this case, the electric wire 91 or the electric wire bundle 92 is easily guided to between the pair of bilateral auxiliary wall portions 521 and the inside of the recessed portion 510. This makes it possible to further suppress the rotation of the harness clamp 1 around the electric wire 91 or the electric wire bundle 92.

In this embodiment, the recessed portion 510 is narrower than the electric wire 91. In this case, the electric wire 91 is pushed into the recessed portion 510 and at least a portion of the outer circumferential portion of the electric wire 91 is accommodated in the recessed portion 510. Therefore, the edges of the recessed portion 510 become unlikely to come out of contact with the electric wire 91. This makes it possible to further suppress the rotation of the harness clamp 1 around the electric wire 91.

In this embodiment, the belt portion 3 and the fixing portion 2 are separately formed. Moreover, the fixing portion 2 is provided with the pair of belt inserting hole portions 25, which is partitioned by the partition plate portion 26 and into which the two end portions of the belt portion 3 can be respectively inserted. The auxiliary wall portion 52 includes the partition-side auxiliary wall portion 522 formed to extend toward the supporting portion 5 side from the partition plate portion 26. In this case, the wall portion 51 is unlikely to collapse in the first direction X due to the partition-side auxiliary wall portion 522 formed in the first direction X. This makes it possible to provide the partition-side auxiliary wall portion 522 in a planar portion partitioning the pair of belt inserting hole portions 25 with a function of suppressing the movement of the electric wire 91 or the electric wire bundle 92 in the first direction X.

### Second Embodiment

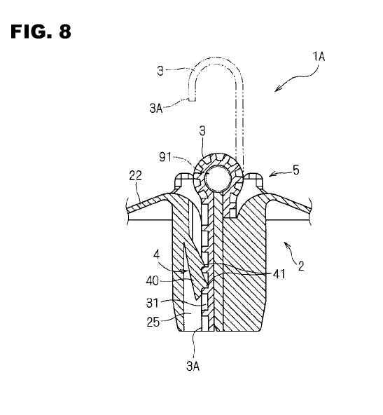

Next, a harness clamp 1A according to a second embodiment will be described with reference to FIG. 8. The harness clamp 1A is different from the harness clamp 1 in that the belt portion 3 and the fixing portion 2 are formed in one piece. It should be noted that in FIG. 8, the components identical to the components shown in FIGS. 1 to 7 are denoted by identical reference numerals. Hereinafter, the difference between the harness clamp 1A and the harness clamp 1 will be described.

In this embodiment, the belt portion 3 is formed such that one end thereof is continuous with the fixing portion 2. The other end of the belt portion 3 serves as a free end. Hereinafter, the end portion serving as a free end in the belt portion 3 is referred to as “lock side end portion 3A”.

In this embodiment, the fixing portion 2 is provided with one belt inserting hole portion 25. Moreover, the belt locking portion 4 is provided inside the belt inserting hole portion 25.

In this embodiment, the locking portions 30 formed on the lock side end portion 3A side of the belt portion 3 are to be locked to the locked portions 41 of the belt locking portion 4 formed inside the belt inserting hole portion 25. By locking the locking portions 31 of the belt portion 3 at the position corresponding to the thickness of the electric wire 91 or the electric wire bundle 92 around which the belt portion 3 is wound and the locked portions 41 of the belt locking portion 4 to each other, the movement of the belt portion 3 in the third direction Z is limited. It should be noted that FIG. 8 shows a form in which the belt portion 3 is wound around the electric wire 91.

In this embodiment, the way in which the lock side end portion 3A of the belt portion 3 wound around the electric wire 91 or the electric wire bundle 92 are inserted into the belt inserting hole portion 25 and the movement of the belt portion 3 in the inserting direction Z is limited is by winding the belt portion 3 that is maintained by the belt locking portion 4.

Also, in the second embodiment, the same effect as in that of the first embodiment can be obtained.

### Application Examples

In the above-described embodiments, a form has been described in which the recessed portions 510 of the wall portions 51 suppress the rotation of the harness clamp 1 around the electric wire 91, whereas the pairs of bilateral auxiliary wall portions 521 suppress the rotation of the harness clamp 1 around the electric wire bundle 92. However, the recessed portions 510 of the wall portions 51 may also suppress the rotation of the harness clamp 1 around an electric wire bundle 92 including a relatively small number of electric wires, whereas the pairs of bilateral auxiliary wall portions 521 may also suppress the rotation of the harness clamp 1 around an electric wire bundle 92 including a relatively large number of electric wires, or the recessed portions 510 of the wall portions 51 may also suppress the rotation of the harness clamp 1 around an electric wire 91 having a relatively small diameter, whereas the pairs of bilateral auxiliary wall portions 521 may also suppress the rotation of the harness clamp 1 around an electric wire 91 having a relatively large diameter.

The fixing portion 2 may have a structure other than the above-described structure. For example, the fixing portion may include a bolt portion in which a screw thread is formed on the outer circumferential surface and a nut portion in which a screw thread is formed on the inner circumferential surface. In addition, the fixing portion may also include a plurality of portions that are formed in a disk spring shape in the inserted portion 21 in the third direction Z.

The auxiliary wall portion 52 may include only one pair of bilateral auxiliary wall portions 521.

The supporting portion 5 may also include one or three or more wall portions 51 and one set or three sets or more of the pair of bilateral auxiliary wall portions 521 in accordance with the number of the wall portions 51.

It should be noted that the harness clamp according to the present invention can be configured by freely combining the above-described embodiments and application examples, or modifying the embodiments and application examples or omitting a portion thereof as appropriate, within the scope of the present invention described in claims.

### LIST OF REFERENCE NUMERALS

1 Harness clamp
1A Harness clamp
Fixing portion
21 Inserted portion
22 Skirt portion
220 Slit
23 Locking claw
230 Locking surface
25 Belt inserting hole portion
26 Partition plate portion
3 Belt portion
3A Lock side end portion
31 Locking portion
4 Belt locking portion
40 Locking claw
41 Locked portion
5 Supporting portion
51 Wall portion
510 Recessed portion
511 Bottom portion
512 Side wall portion
514 Connecting portion
519 Front end-side edge portion
52 Auxiliary wall portion
521 Bilateral auxiliary wall portion
522 Partition-side auxiliary wall portion
8 Fixing counterpart portion
91 Electric wire
92 Electric wire bundle
X First direction
Y Second direction
Z Third direction

What is claimed is:

1. A harness clamp for fixing an electric wire or an electric wire bundle to a fixing counterpart portion, the harness clamp comprising:
a fixing portion that includes a supporting portion configured to suport the electric wire or the electric wire bundle and can be fixed to the fixing counterpart portion;
a belt portion configured to be wound around the electric wire or the electric wire bundle on the supporting portion side of the fixing portion; and
a belt locking portion configured to be locked to the belt portion to maintain the belt portion in a winding form in which the belt portion is wound around the electric wire or the electric wire bundle,
wherein the supporting portion includes a wall portion extending in a second direction intersecting a first direction that is a direction in which the electric wire or the electric wire bundle extends, and a front end-side edge portion of the wall portion including a recessed portion configured to accommodate at least a portion of an outer circumferential portion of the electric wire or the electric wire bundle.

2. The harness clamp according to claim 1,
wherein the supporting portion further includes an auxiliary wall portion continuous with the wall portion and extending in the first direction.

3. The harness clamp according to claim 2,
wherein the auxiliary wall portion includes a pair of bilateral auxiliary wall portions formed outside on both sides of the recessed portion.

4. The harness clamp according to claim 3,
wherein the wall portion is lower than the bilateral auxiliary wall portions.

5. The harness clamp according to claim 4,
wherein the wall portion is formed in a shape in which a height of portions that connect portions continuous with the bilateral auxiliary wall portions and the recessed portion gradually decreases toward the recessed portion.

6. The harness clamp according to claim 2,
wherein the belt portion and the fixing portion are separately formed,
the fixing portion includes a pair of belt inserting hole portions that is partitioned by a partition plate portion and into which two end portions of the belt portion can be respectively inserted, and
the auxiliary wall portion includes a partition-side auxiliary wall portion formed to extend toward the supporting portion side from the partition plate portion.

7. The harness clamp according to claim 1,
wherein the recessed portion is narrower than the electric wire.
